(19) United States
(12) Patent Application Publication
(10) Pub. No.: US 2010/0169219 A1
(43) Pub. Date: Jul. 1, 2010

(54) PLUGGABLE HEALTH-RELATED DATA USER EXPERIENCE

(75) Inventors: Timothy D. Sellers, Redmond, WA (US); Margaret E. Rottsolk, Seattle, WA (US); Hubert Van Hoof, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/346,710

(22) Filed: Dec. 30, 2008

(51) Int. Cl. H04L 9/32; G06Q 50/00

(52) U.S. Cl. 705/51; 705/2

(57) ABSTRACT

A pluggable user experience (UX) system that enables users to access third party wellness applications and services that leverage centralized healthcare data is provided. The UX can be accessed by way of an employer's intranet, Internet or other suitable network. The system is capable of verifying user identity as well as authorization to third party wellness applications. These wellness applications can be used to leverage centralized healthcare data in accordance with permissions granted by the owner of the healthcare data/records.

### BACKGROUND

Recent trends in the healthcare industry have been directed to centralizing storage of healthcare data. This centralization has great benefit to both healthcare entities as well as patients. For instance, transfer of or access to records can be accomplished virtually instantaneously by way of a network connection. Most of these solutions leave the individual patient in control of access to and sharing of their information.

In accordance with centralized storage of healthcare records, individuals are able to make more informed health decisions for themselves and their family. By vesting control of the information in the owner of the information, decisions with regard to sharing or use can be based upon trust, relationship or other parameter. For example, an owner can choose to share their healthcare information with one entity while blocking access by another. Additionally, a user can choose to share healthcare information with an employer while shielding access from a particular service provider (e.g., insurance company).

Because the healthcare information and records are stored in a centralized, network-accessible locations (e.g., Internet), the patient should be able to use their health information wherever and whenever they want. As stated above, it can be possible to share the information, or portion of the information, as desired. In most approaches, access can be regulated by the owner of the information based upon entity, type of information, amount of information, or other desired parameter.

Most recently, centralized healthcare data services are working with doctors, hospitals, employers, pharmacies, insurance providers and manufacturers of health devices (e.g., blood pressure monitors, heart rate monitors) to make it easy to add information electronically to the centralized healthcare record.

With a more complete picture of a family's health, an individual can work with healthcare professionals and with authorized service providers (e.g., Web sites) that connect with healthcare data to make more informed health-related decisions. Unfortunately, traditional approaches have not been designed to integrate with corporations, organization or other groups. Thus, these entities are not able to leverage the powerful benefits of the centralized storage of healthcare data.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a pluggable user experience (UX) that enables users to access wellness applications and services (e.g., third party applications) that leverage the concept of centralized healthcare data. In aspects, the UX can be accessed by way of an employer's intranet. In this example, the user can discover wellness applications and/or services, granting select applications access to their healthcare records from a centralized store.

In aspects of the subject innovation, username/password, challenge/response or biometric mechanisms can be employed to verify identity or authenticate the user. A single sign-on can be used such that user credentials entered to log into the employer's system or intranet can be employed to authorize access to a set of wellness applications.

In yet another aspect thereof, a machine learning and reasoning component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example pluggable user experience (UX) management system in accordance with aspects of the innovation.

FIG. 2 illustrates an example flow chart of procedures that facilitate pluggable access to wellness applications in accordance with an aspect of the innovation.

FIG. 3 illustrates an example flow chart of procedures that facilitate connecting an employee identity to a centralized healthcare data account in accordance with an aspect of the innovation.

FIG. 4 illustrates an alternative block diagram of a pluggable UX management system that facilitates leverage of centralized healthcare data concepts in accordance with aspects of the innovation.

FIG. 5 illustrates an example identity validation component that can authenticate a user based upon a variety of inputs in accordance with aspects of the innovation.

FIG. 6 illustrates an example architecture that includes a machine learning and reasoning component that can automate functionality in accordance with an aspect of the innovation.

FIG. 7 illustrates a block diagram of a computer operable to execute the disclosed architecture.

FIG. 8 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

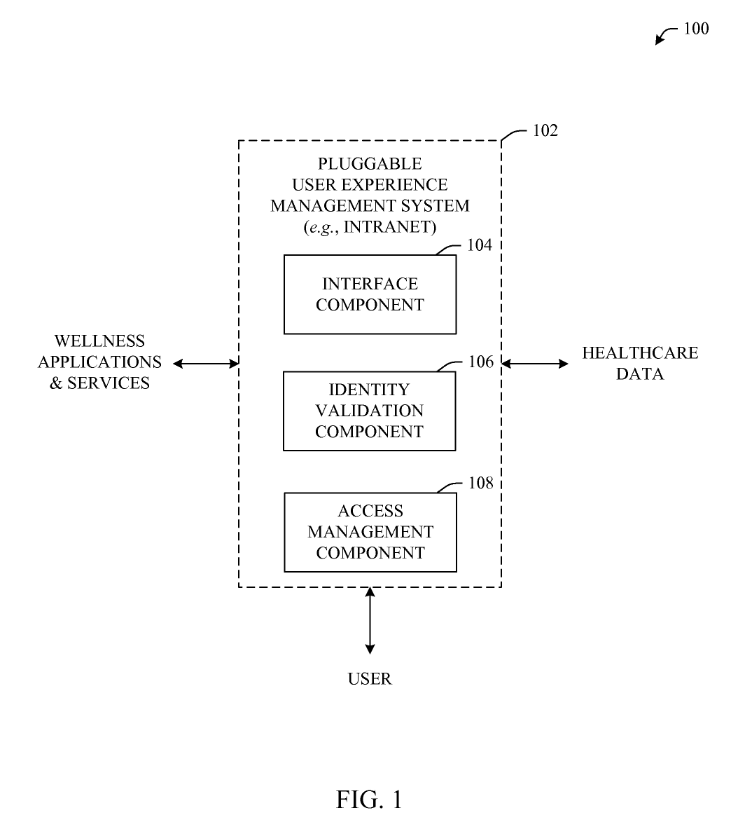

Referring initially to the drawings, FIG. 1 illustrates a system 100 that facilitates interaction from an employer's network to a variety of wellness applications and/or services that communication with a centralized healthcare data service. For example, in aspects, the innovation discloses integration between an employer's network (e.g., intranet) and third-party wellness sites and services designed to share and access data from a centralized healthcare data store.

In operation, a user (or employee) can grant access to healthcare records within the centralized store. As shown, a pluggable user experience (UX) management system 102 can act as a gateway between an employer's intranet and a set of third party wellness applications and services that leverage a centralized healthcare data store. Essentially, the user (or employee) can access the management system 102, for example by way of the employer's intranet or other suitable network. While specific examples described herein are directed to company intranet access, it is to be understood that other aspects provide access by way of other networks, for example, the Internet, cell networks, or the like.

Generally, the pluggable UX management system 102 can include an interface component 104, an identity validation component 106 and an access management component 108. Together, these sub-components (104, 106, 108) provide user control (e.g., data access definition), security/authentication and authorization. Each of these sub-components will be described in greater detail with reference to the figures that follow.

By way of example, suppose that an employer promotes health and wellness as a benefit to employees. In doing so, a third-party virtual trainer website is available for employees to access free of charge. As shown in FIG. 1, this wellness application/service can use a centralized healthcare data store to store, retain and/or retrieve data. For instance, as users workout, data such as heart rate, calories burned, distance travelled, etc. can be automatically tracked and stored within the centralized data store.

The interface component 104 provides a gateway for communication between the third party wellness application and/or services to the centralized healthcare store. This communication is established by way of a network, for example, an employer's intranet. The interface component 104 provides user interfaces by which a user can grant access to their private healthcare data (or subset thereof). For instance, specific access rights can be given to specific providers. In other words, access can be limited to the data that is used in the service provided by the third-party service (e.g., exercise-related data).

Additionally, the interface component 104 enables a user to set and/or select sign-on credentials. For example, a user can select and/or modify their username, password, etc. by way of the interface component 104. Where biometrics are used to establish identity, the interface component 104 can be used to learn, train or gather biometric data, e.g., fingerprints, etc.

Still further, the interface component 104 effects the integration of the wellness application and services into the pluggable UX management system 102. As described above, the UX management system 102 can essentially be an employer intranet or other network accessible interface.

The identity validation component 106 is employed to authenticate a user. Here, the authentication can be specific to a particular person's identity and/or authority to access other's healthcare data. In aspects, a user might opt to use a wellness application based upon their own data—in which case, once their identity is proven, data access can be granted. In other aspects, for example a parent/child relationship, a parent's identity can be proven after which, confirmation of authority to grant access to a child's data can also be verified.

Here, authentication and/or identity validation can be accomplished by way of most any mechanism. In specific examples, a username/password combination can be used. In other aspects, challenge/response mechanisms can be used to validate identity—whereby, personal questions (e.g., challenges) can be posed. As will be appreciated, these types of questions can most often only be answered by the owner of the data. In still other aspects, biometrics can be employed to validate identity.

In particular examples, the identity validation component 106 provides for single-sign-on functionality. By way of example, once a user signs- or logs-in to their company intranet, this validated identity can be used to access a variety of applications or services. The access management component 108 can regulate which wellness applications and services can be accessed following a confirmed identity authentication, e.g., without a need to re-enter identity credentials.

The access management component 108 maintains information regarding which applications & services are accessible by which identities or users. Further, the access management component 108 can communicate with the interface component 104 to establish which data is accessible to which applications/services, for example, based upon the defined policies, preferences or rules.

As described herein, many large employers are enthusiastic about centralized healthcare records and want to ensure their employees have healthcare record access accounts and benefits programs that interoperate with a centralized store. The innovation disclosed herein provides the integration between the centralized store and application/service providers. Employers appreciate the value in their employees being able to keep their important medical data in a safe place that the employees control.

Employers recognize that centralized data has the potential to ease the pain employees feel when changing their insurance plans and/or doctors by making their personal health data more portable. Many such employers are discovering how much wellness programs in the work place reduce absenteeism and presenteeism by improving employee health and wellness overall. This in turn improves the employer's bottom line by reducing health insurance costs, sick days, and improving overall productivity. Additionally, the employers see centralized data as a way to increase user participation in wellness programs, since the data they enter stays with the employee and can be shared between wellness programs (e.g., third party application/services), their doctors, and other individuals as they choose. It is important to note that the innovation described herein is sensitive to privacy concerns and regulations. Users are able to opt-in or opt-out as they desire. Still further, it is to be appreciated that employee-controlled access can be limited to data based upon most any desired granularity.

Unfortunately, although attempts have been made to establish centralized healthcare data stores, conventionally, there is still is still an integration gap that prohibits employers to benefit from this centralization. The innovation disclosed herein bridges the gap by providing a pluggable UX by which employers are able to make wellness application/services available to employees. While many of the aspects are described in terms of an employer/employee relationship, it is to be understood that the features, functions and benefits presented herein can be used in most any scenario whereby wellness application/service use can be leveraged and offered to a user, for example, via a pluggable UX.

Continuing with the employer/employee scenario, most large employers (and many smaller employers) have some sort of intranet site with information about health benefits for employees. Thus, to make their various wellness or centralized healthcare data-compatible applications available and discoverable to their employees, it is important to incorporate information about these applications/services into their intranet. The innovation provides for a pluggable UX that enables visibility and access.

To ensure security and control dissemination of data, the innovation is capable of validating identity of employees and their insured family members or dependents. For example, suppose that one of the wellness applications available to employees and their family members enables them to save their insurance claims data into their centralized healthcare data accounts. In most scenarios, access to this application from the Internet is important so a covered (or eligible) family member who does not have access to the employer's intranet can still use the application.

In order for this to work while maintaining security of the data, the innovation provides for mechanisms by which an employee's family member can verify their identity as a covered person. Thus, access to the application can be granted. It will be understood and appreciated that identity validation can also be effected in scenarios where the employee wants to access the application from the Internet or intranet.

The innovation can also provide a single sign-on (SSO) feature for employers who do not want their employees to have to manage separate usernames and passwords (or other credentials) for most every health-related application they may want to offer. The innovation is able to ensure that the third party health management tools available to employees can be accessed from the intranet (or Internet or other network) without the employee being required to enter additional usernames and passwords. It will be appreciated that these aspects provide that the sign-on experiences be simple to use and to implement, from both the intranet and Internet.

Essentially, once a user identity is validated, authorization to access centralized data-equipped wellness sites, applications and services can be established. As described above, this authorization can be based upon a single sign-on or alternatively, each wellness site can require its own authorization scheme. In either scenario, access to the wellness sites can be effected from an employer intranet (or other site) whereby data is shared from a centralized store. As can be appreciated, this ability to plug wellness sites into an employer's intranet can greatly enhance the ability to leverage a centralized healthcare data record storage service.

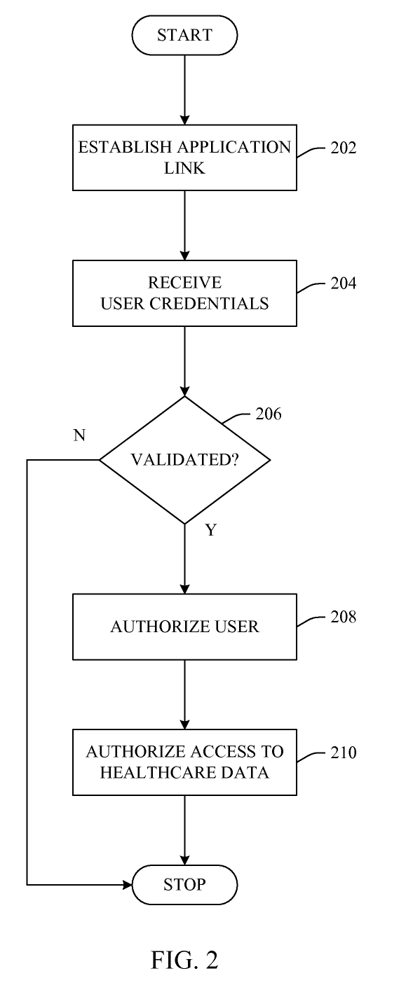

FIG. 2 illustrates a methodology of establishing a pluggable link into a centralized healthcare data system in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a link is established from an intranet to a wellness application provider. For example, here, a user is able to see (and link to) a variety of third-party wellness applications and/or services that are capable of accessing healthcare data from a centralized store. The accessibility and establishment of the application link at 202 can be accomplished by way of standard plug-in or other similar technologies. In aspects, the user can browse and/or access available applications and services from a home page, for example, on an employer intranet site.

At 204, user credentials can be received to validate a user identity. Here, the credentials can be a username/password combination, biometric data, etc. Other aspects can employ challenge/response mechanisms to ensure proper identity. A determination is made at 206 to establish if identity is proven. If not, the methodology ends as shown.

If proper identity is validated, at 208 the authorization process is commenced. Here, authorization to use or otherwise access third party wellness sites can be established. As well, authorization of the third party wellness sites to access the user's health records from the centralized healthcare location is also established at 210.

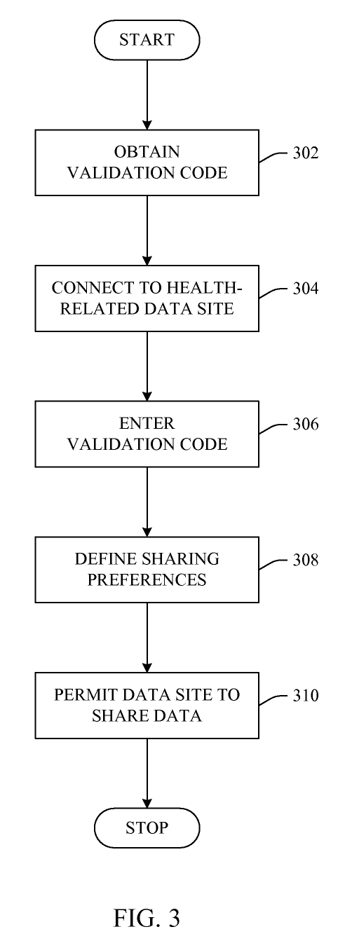

Referring now to FIG. 3, there is illustrated a methodology of connecting an employee identity to a centralized data account in accordance with an aspect of the innovation. At 302, a validation code can be obtained. For instance, an employee can obtain a validation code from his employer's intranet site. Here, a call is made to a centralized healthcare data system. Thereafter, a unique identification (ID) is passed for the employee. Additionally, an optional challenge question is passed.

At 304, connection is made to the centralized healthcare data site. Integration into the centralized site takes place under a specialized platform capable of accessing data and health records from the centralized location. Once connected, at 306, the user enters his secret code (e.g., unique ID) and optionally an answer to the security question. Additionally, the user can confirm the name of his employer as an additional identification parameter.

Sharing (and access) preferences, policies and rules can be defined at 308. In other words, a user can confirm the data access that he desires to grant to the employer. It is to be understood and appreciated that sharing and access control remains vested in the owner of the health records. As well, an owner is able to grant access in most any granularity as desired. For example, specific types of data can be released, data can be released for a specified period of time, etc. as desired by a user or owner of the data. Finally, at 310, the data site is permitted to share data as specified by the owner.

The employer's system can poll the centralized data site to learn that it has access to an employee's health record data. For each new record, the centralized data site returns the unique employee ID. This unique employee ID enables the clinical system to map the data to the correct patient, owner or user.

In accordance with the methodology of FIG. 3, if the employee is connecting from the intranet straight to the centralized data site, the validation code should be sent along to effect a single sign-on whereby the user would not have to copy/paste or re-enter the code between web pages. Additionally, the innovation can provide the ability for the employee to retrieve codes for his family members so that they have them on hand, for example, when they log into the system via the Internet.

This code is most often stored in the user's healthcare data site account so participating wellness applications/services can use the code to identify the user as an employee of a particular employer. As multiple family members can be associated to an employee, multiple codes can be stored per user.

In one aspect, the code can have at least two portions, an employer-group portion and a unique employee ID. In this manner, partner applications (e.g., wellness applications/services) can choose if they simply need to identify the user as a generic employee of the employer or, alternatively, if they need to identify the user as a particular employee with particular rights, insurance coverage, permissions, etc.

In aspects, third party applications/services can be responsible for retrieving the list of valid, current, employee codes and handling their expiration as appropriate for a given application. In other words, for a payer, the application can obtain the code for the user from the employer, store it in their existing identity table for that user. The code can be employed if/when that user logs into the payer's Web application to download claims data to their healthcare account. Here, the Web application can match the user ID code to the one for that employee in their own table so as to ensure download of the correct data. If/when the user changes insurance plans, the payer's application can handle the change appropriately.

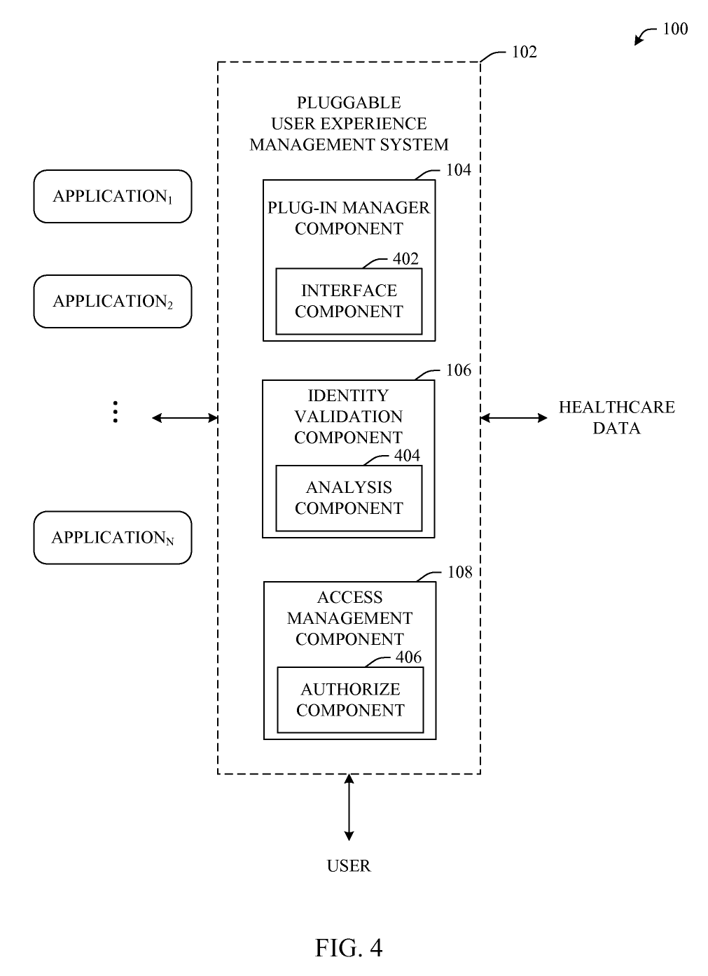

Turning now to FIG. 4, an alternative block diagram of a pluggable UX management system 102 that facilitates access of wellness applications and/or services (e.g., third party applications) via an employer intranet in accordance with aspects of the innovation is shown. As illustrated, the plug-in manager component 104 can include an interface component 402. As described above, the interface component 402 is capable of presenting a user with a series of UIs by which wellness applications can be selected directly from an employer intranet.

Effectively, the wellness applications and services can be plugged into the intranet offerings by which a user can leverage healthcare data stored within a centralized location (or set of distributed locations). While a ‘centralized’ location is described herein, it is to be understood that a series or set of distributed locations can be employed to store health-related data (e.g., records) without departing from the spirit and/or scope of the innovation.

It will be appreciated that most large employers have some sort of intranet site with information related to health benefits for employees. Thus, to make their various applications capable of accessing data from a centralized store available and discoverable to their employees, it important to incorporate information about them into their intranet. Here, the innovation's plug-in manager component 104 effects making a set of wellness applications and/or services available by way of the company's intranet (or other network site). It will be appreciated that, because the innovation enables simply pluggable wellness applications, more and more employers will most likely invest the effort of adding ways to discover applications to their employee portals which access centralized healthcare data.

Referring again to FIG. 4, as shown, the identity validation component 106 can include an analysis component 404 that provides logic capable of validating a user identity. As described above, the identity can be validated by way of username/password combinations, challenge/responses, biometrics, etc. In addition to establishing the user identity, the innovation can also verify the subject identity, for example, in the instance of a parent/child relationship.

As described supra, the innovation is capable of establishing identity validation for employees and their insured family members. For example, one of the applications available to employees and their family members can enable them to save their insurance claims data into their centralized healthcare accounts. In aspects, the innovation enables access of the wellness applications by way of the Internet, for example, so that a covered family member who does not have access to the employer's intranet can still use the application.

Therefore, the innovation provides for mechanisms by which non-employees such as family members of the employees (and the employees themselves) are able to verify their identity. In one aspect, this identity validation can be accomplished by way of the Internet, e.g., using usernames/passwords, challenges/responses, biometrics, etc. An example of connection of an employee identity to a centralized healthcare data store is described with regard to FIG. 3 supra.

As shown in FIG. 4, the access management component 108 can include an authorize component 406 that is capable of determining authority to access the wellness applications (or a subset thereof). As illustrated, 1 to N applications can be effectively ‘plugged-into’ the UX management component 102, where N is an integer.

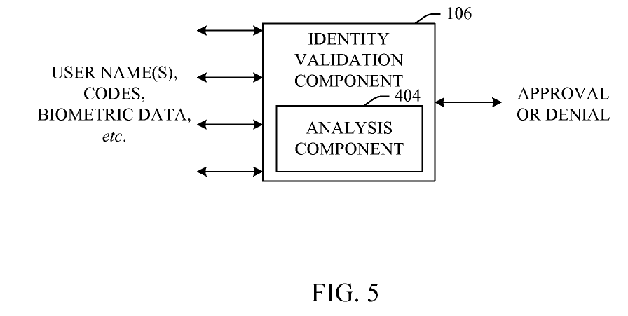

FIG. 5 illustrates an example block diagram of an identity validation component 106. As shown, the analysis component 404 can be employed to authenticate the user. A username/password combination, unique codes, biometric data, etc. can be employed to authenticate the identity of a user.

In aspects, an employee can discover applications capable of accessing centralized healthcare data systems. The applications can be made available to the employee and his family, for example, via his employer's internal web portal. In this scenario, the discovered applications can have a variety of manners by which authentication can be implemented.

First, the application may have its own authentication system, entirely independent from the employer. In this case, if the user selects (e.g., clicks on) a link to an application, they can be prompted to create a new username and password for that application. Here, the username and password can later be used to authenticate the identity of the data owner.

In another aspect, the application may be linked into and share the employer's internal authentication system. This can happen in at least a couple of ways.

First, the employee can use his work credentials to log into the application. This case works well for applications (e.g., open enrollment benefits tool) that the employee only needs to access from the intranet. As well, this option is helpful for access to applications that will no longer be available to him after he leaves the company. Still further, this option is helpful for access to applications that the employee's family members do not need direct access to via the Internet.

Second, the employee can access the application directly from his employer's intranet site. In addition to direct access, the employee can also associate some other unique ID (e.g., LiveID) for himself and his family members to access the application from the Internet. This scenario works well for applications that the employee may want to access from outside of his employer's intranet. As well, the unique ID scenario is helpful for access to applications that the employee's family members need access to and/or that the employee may want to continue using after he is no longer with the employer. An application in this category may be a wellness application (e.g., for a 20/20 program at the ProClub) that is subsidized by the employer, but that the employee could still use at a different cost, if he is no longer with the company.

In yet a third aspect, the employee can access the application directly from his employer's intranet site using an authentication mechanism specific to the centralized healthcare data repository. Here, the data repository's authentication mechanism is the only authentication mechanism supported by the application. In this scenario the centralized data repository requires that users can associate existing centralized healthcare data accounts with a given application. Therefore, if the applications have already been using the data repository, they can leverage the data they have there in the existing application they are using from their employer. Additionally, users can have complete control over their healthcare accounts and the data (e.g., records) held within them. Still further, users can continue to have access to their healthcare accounts via their healthcare repository-specific ID after they are no longer with the employer.

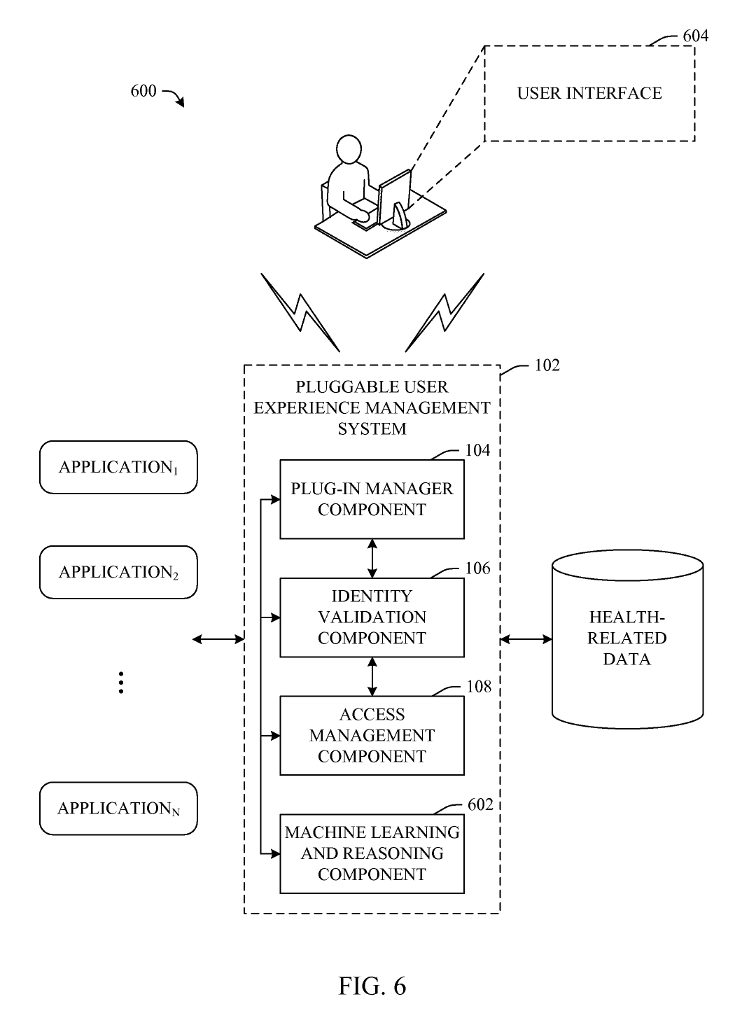

FIG. 6 illustrates a system 600 that employs a machine learning and reasoning (MLR) component 602 which facilitates automating one or more features in accordance with the subject innovation. The subject innovation (e.g., in connection with granting data/record sharing privileges/rights) can employ various MLR-based schemes for carrying out various aspects thereof. For example, a process for determining when/if to grant access to healthcare data, what subset of records to grant access, which applications can employ the records, etc. can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when/if and to what extent to grant access to healthcare data and records.

With continued reference to FIG. 6, a user interface (UI) 604 can be provided which enables a user to enter preferences, define sharing rights, etc. As well, the UI can be employed to present and facilitate selection of wellness applications and/or services. As described supra, the UI can be rendered via an employer's intranet, the Internet or other network or computerized source/server.

In an aspect, an employee can use the UI to discover compatible wellness applications available to him and his family via a searching mechanism, e.g., Internet-based search. The UI can be used to effect identity verification and other single sign-on functionality as described above.

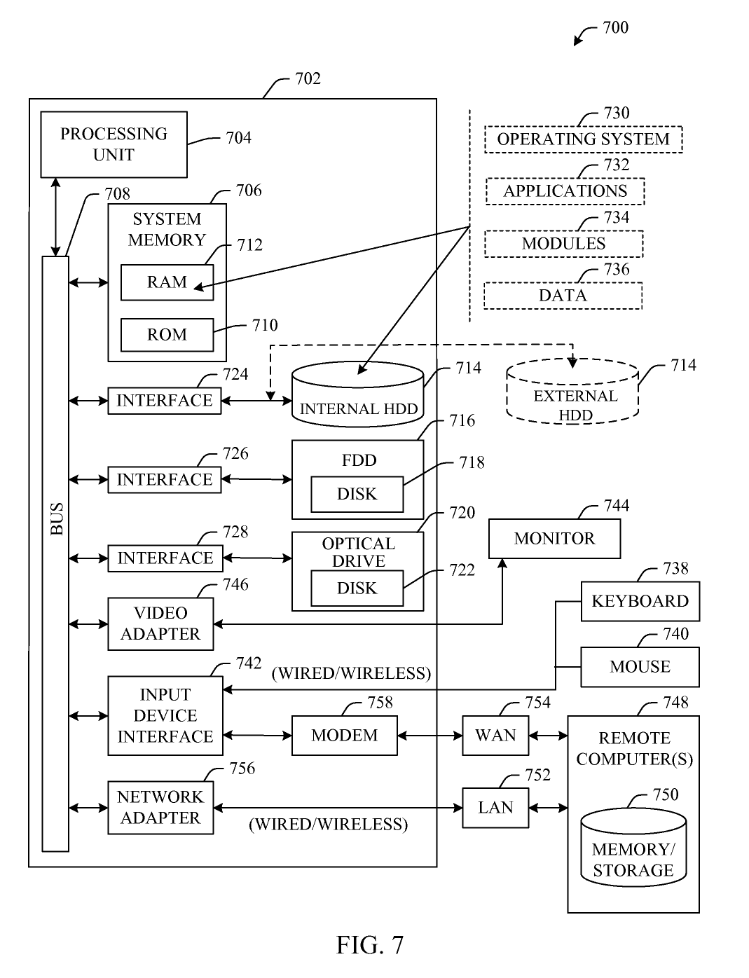

Referring now to FIG. 7, there is illustrated a block diagram of a computer operable to execute the disclosed architecture. In order to provide additional context for various aspects of the subject innovation, FIG. 7 and the following discussion are intended to provide a brief, general description of a suitable computing environment 700 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects of the innovation includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the innovation can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

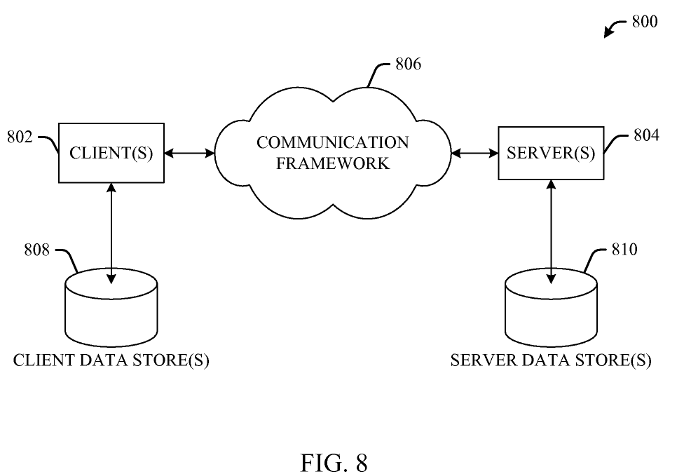

Referring now to FIG. 8, there is illustrated a schematic block diagram of an exemplary computing environment 800 in accordance with the subject innovation. The system 800 includes one or more client(s) 802. The client(s) 802 can be hardware and/or software (e.g., threads, processes, computing devices). The client(s) 802 can house cookie(s) and/or associated contextual information by employing the innovation, for example.

The system 800 also includes one or more server(s) 804. The server(s) 804 can also be hardware and/or software (e.g., threads, processes, computing devices). The servers 804 can house threads to perform transformations by employing the innovation, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates utilization of a centralized healthcare data storage system, comprising:
a plug-in manager component that facilitates access to a plurality of wellness applications via a network; and
an identity validation component that authenticates an owner of data stored within the centralized healthcare data storage system, wherein the owner is granted access to a subset of the wellness applications.

2. The system of claim 1, wherein the network is an employer intranet.

3. The system of claim 1, wherein the network is the World Wide Web network.

4. The system of claim 1, further comprising an access management component that authorizes the access to the subset of the wellness applications.

5. The system of claim 1, wherein authentication is established based at least in part upon one of a user/password combination, a unique code, a challenge/response combination or biometric data.

6. The system of claim 5, further comprising an analysis component that employs logic to effect the authentication based at least in part upon the one of the user/password combination, the unique code, the challenge/response combination or the biometric data.

7. The system of claim 1, further comprising a user interface component that facilitates the owner to grant access to a subset of the data within the centralized healthcare data system.

8. The system of claim 7, wherein the access is based at least in part upon a subset of the wellness applications.

9. The system of claim 1, wherein the authentication effects a single sign-on that authenticates the identity with the subset of wellness applications upon logging into the network.

10. The system of claim 1, further comprising a machine learning and reasoning component that employs at least one of a probabilistic and a statistical-based analysis that infers an action that a user desires to be automatically performed.

11. A computer-implemented method of accessing a centralized healthcare data system, comprising:
granting access of owner-specific information from the centralized healthcare data system to an employer network by way of a specialized user interface;
linking a plurality of wellness application to the employer network; and
transferring a subset of the owner-specific information to a subset of the plurality of wellness applications via the employer network.

12. The computer-implemented method of claim 11, wherein the employer network is an employer intranet.

13. The computer-implemented method of claim 11, further comprising authenticating identity of a user, wherein the authenticated identity is employed to access the subset of the owner-specific information.

14. The computer-implemented method of claim 13, wherein the act of authenticating employs at least one of a user/password combination, challenge/response combination, unique user-specific code or biometric information.

15. The computer-implemented method of claim 14, further comprising discovering the access grant associated with the owner-specific data.

16. The computer-implemented method of claim 15, wherein the act of discovering includes polling the employer network to discover access rights.

17. The computer-implemented method of claim 11, further comprising receiving instruction from the user, wherein the instruction defines scope of the grant of access.

18. A computer-executable system comprising:
means for generating a unique code that relates a user to specific healthcare data within a centralized store;
means for transferring the unique code to an employer network; and
means for linking a wellness application to the employer network wherein the unique code is employed to transfer a subset of the specific healthcare data between the centralized store and the wellness application.

19. The computer-executable system of claim 18, further comprising means for authenticating the user to the employee network, wherein the unique code is generated based upon a positive authentication.

20. The computer-executable system of claim 19, wherein the authentication of the user is employed to authorize access to the wellness site.
